(19) United States
(12) Patent Application Publication
(10) Pub. No.: US 2013/0001952 A1
(43) Pub. Date: Jan. 3, 2013

(54) Generator Assembly for a Wind Power Plant

(75) Inventors: Anton Paweletz, Fellbach (DE); Heinz-Josef Tenberge, Sprockhovel (DE)

(73) Assignee: ROBERT BOSCH GMBH, Stuttgart (DE)

(21) Appl. No.: 13/517,033

(22) PCT Filed: Dec. 9, 2010
(86) PCT No.: PCT/EP10/07496

§ 371 Date: Sep. 4, 2012

(30) Foreign Application Priority Data
Dec. 19, 2009 (DE) 10 2009 059 671.2

(51) Int. Cl. F03D 9/00; H02K 7/116

(52) U.S. Cl. 290/55; 310/83

(57) ABSTRACT

A generator assembly for a wind power plant includes an annular stator, an annular rotor, and a spur gear transmission assembly. The generator assembly includes a basic carrier component on which all the bearings of the generator assembly are arranged.

The present invention relates to a generator assembly for a wind energy installation.

### PRIOR ART

A large proportion of the known wind power plants or wind energy installations is equipped with quickly rotating generators, wherein single-stage or multiple-stage gears are used to convert the relatively slow revolution speed of the wind wheel into the generator revolution speed. Solutions are known in which gears and generators are arranged in series as separate assemblies on a machine mount. This makes it possible, in the event of any damage, to replace the components in a simple manner, but the overall assembly is relatively large and heavy, which results in problems in respect of transport into the pod of the wind energy installation and the arrangement therein.

Furthermore, assemblies are known in which a gear arrangement is arranged at least partially within the generator, which results in a space saving. Exemplary solutions are disclosed in DE 102 42 703 B3 or DE 10 2004 005 543 A1. However, one disadvantage with these solutions is the complex mounting of the individual gear and generator elements with respect to one another. In this case, two bearings are generally provided for each degree of freedom of the gear, i.e. the number of possible independent movements. For example, in the cited DE 102 42 707 B3, the sun wheel and the ring gear are each mounted twice on the planet carrier, with the result that the gear arrangement comprises in total four bearings. The tolerances which need to be adhered to in manufacture are therefore low since, in the fitted state, a large number of component parts move relative to one another, which quickly results in wear in the event of excessive play.

It is therefore desirable to specify a generator assembly comprising a gear for a wind energy installation which has a compact design, manages with as few bearings as possible and requires little manufacturing complexity.

### DISCLOSURE OF THE INVENTION

According to the invention, a generator assembly for a wind energy installation having the features of patent claim 1 is proposed. Advantageous configurations are the subject matter of the dependent claims and the description below.

### ADVANTAGES OF THE INVENTION

The invention is based substantially on the concept of providing a base mount component part which bears all of the bearings of the generator assembly and the gear. Such a design has the advantage that all of the centering faces, such as the stator stack with respect to the stator housing, for example, and all of the bearing seats are related to a common reference, for example the base axis of the stator. It is particularly advantageous that all of the centering and bearing faces can be machined while being held in a chuck only once during manufacture. As a result, the component parts can be arranged more precisely such that any air gaps between in particular the stator and the armature are smaller and therefore the generator power density is increased.

It is possible for the armature and/or at least one gear wheel, preferably two or all of the gear wheels, of the spur gear arrangement to be mounted rotatably on the base mount component part. If, furthermore, a shaft bearing one of the gear wheels of the spur gear arrangement also bears the armature, mounting of both elements can be provided in a simple manner by mounting the shaft on the base mount component part.

Furthermore, the generator assembly with the spur gear can be fitted and dismantled more easily since the relation to a common reference in particular permits the use of simple fitting methods, such as a toothed plug-type connection. In one configuration, the armature and/or the gear wheel can be connected to the shaft by means of an in particular toothed plug-type connection. It is also possible for the gear wheel to be part of the shaft. In other words, the shaft can be serrated at one end and engage in a further gear wheel of the spur gear.

In the case of the generator assembly with the gear, the generator and the gear can be in the form of a joint unit, with preferably the space within the armature being used to accommodate at least part of the gear, which shortens the force flow paths. As a result, said parts can have a smaller construction and can be produced with a lower consumption of material. At the same time, it is possible for the generator assembly with the gear to be configured from assemblies which are easier to handle without negatively influencing tolerances of the bearing arrangement systems. In particular, in contrast to the prior art, it is also possible simply for a spur gear to be used instead of a complex planetary gear.

In a preferred configuration, the base mount component part is in the form of a pot with a bottom face and a wall face, wherein the stator of the generator is arranged on the wall face. As a result, it is possible to dispense with separate mount elements since the stator is arranged directly on the base mount component part, which can additionally advantageously act as housing. As a result, it is possible to dispense with a separate housing, which results in a significant space and weight saving. In other words, the housing is formed at least partially by the base mount component part itself.

In one configuration, a second gear arrangement, in particular a two-stage gear, is connected upstream of the spur gear arrangement. Overall, it is thus possible to provide a high transmission ratio which is required for certain generators, with less space and weight being required than is the case with known three-stage gears with a downstream generator.

Expediently, the second gear arrangement and the spur gear arrangement are connected to one another by means of at least one elastic element. In this way, it is possible to firstly ensure that the gear arrangements can be provided independently of one another and only need to be connected to one another at the use location. The elastic elements secondly serve the purpose of absorbing torque shocks.

Further advantages and configurations of the invention result from the description and the attached drawing.

It goes without saying that the features mentioned above and yet to be explained below can be used not only in the respectively given combination, but also in other combinations or on their own without departing from the scope of the present invention.

The invention is illustrated schematically using exemplary embodiments in the drawing and will be described in detail below with reference to the drawing.

### DESCRIPTION OF THE FIGURES

FIG. 1 shows a cross-sectional view of a first preferred embodiment of a generator assembly according to the invention.

FIG. 2 shows an exploded view of the embodiment shown in FIG. 1.

FIG. 3 shows a cross-sectional view of a second preferred embodiment of a generator assembly according to the invention.

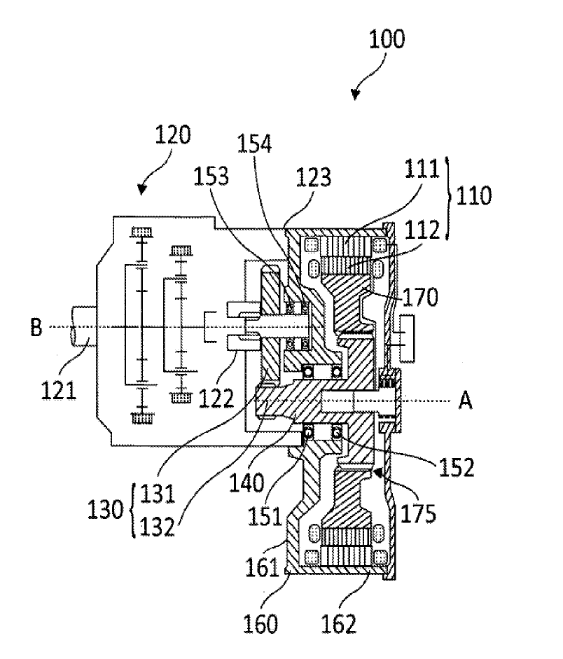

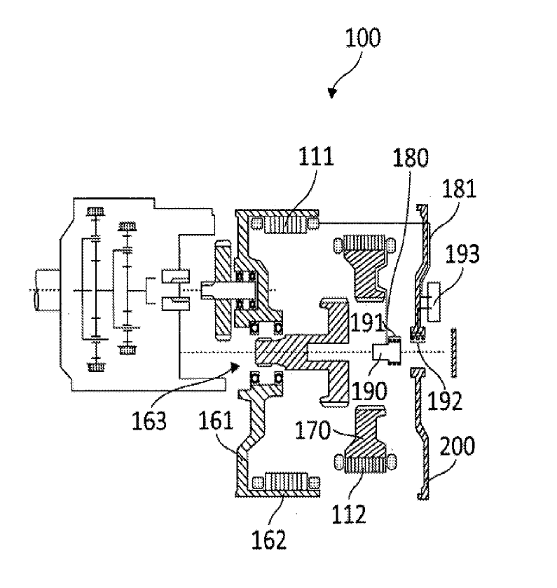

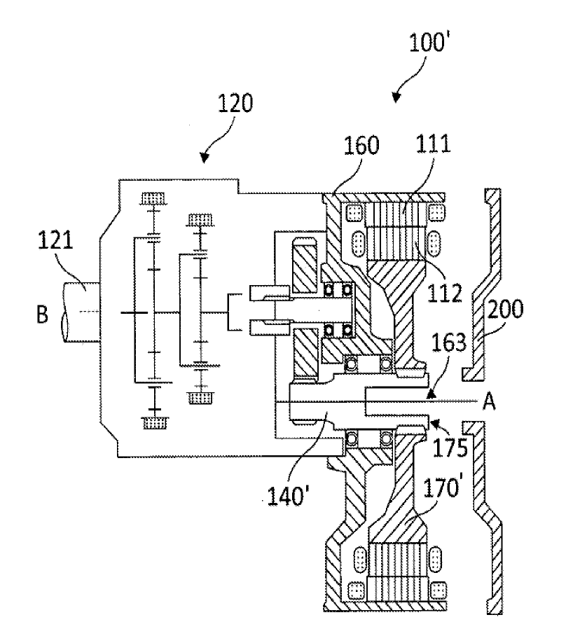

FIGS. 1 and 2, on the one hand, and FIG. 3, on the other hand, show different configurations of a generator assembly according to the invention, but these configurations will be described in all-encompassing fashion below insofar as they contain identical or functionally identical elements. Said elements have been provided with the same reference symbols.

FIGS. 1 and 2 illustrate a first preferred embodiment of a generator assembly according to the invention schematically in cross section, which is denoted overall by 100. The generator assembly 100 comprises a double-fed asynchronous generator 110 with a stator 111 surrounding a coil arrangement and an armature 112 surrounding a coil arrangement, the end windings of said stator and said armature being depicted on the right-hand side and the left-hand side, respectively. The armature 112 is mounted rotatably about an axis of rotation A.

The generator assembly has a base mount component part 160, which at the same time acts as housing part and which, in the present example, is in the form of a pot with a bottom face 161 and a wall face 162. The stator 111 is fastened to the inner side of the wall face 162.

The base mount component part 160 furthermore has a central cutout 163, in which a shaft 140 is mounted. The armature 112 is fitted to an armature mount 170, which is connected in rotationally fixed manner to the shaft 140 by means of a toothed plug-type connection 175. The shaft 140 is mounted rotatably about the axis of rotation A with respect of the base mount component part 160 by means of bearings, in this case in the form of ball bearings 151 and 152.

The generator assembly 100 furthermore comprises a spur gear arrangement 130, which is likewise mounted on the base mount component part 160 and, together with the asynchronous generator 110, is part of the generator assembly. The spur gear arrangement 130 has a first gear wheel 131 and a second gear wheel 132, which is formed as part of the shaft 140. The gear wheel 131 is mounted rotatably about an axis of rotation B with respect to the base mount component part 160 by means of bearings in this case in the form of ball bearings 153 and 154, said axis of rotation B in the example shown coinciding with the axis of rotation of the input drive shaft 121.

The generator assembly 100 in the illustration shown is connected to a two-stage series gear 120, which is connected to an input drive shaft 121, which is connected, for example, to a wind wheel or rotor (not shown). The series gear 120 in the present example has two planet gear stages and is connected to the gear arrangement 100, more precisely to the gear wheel 131 of the spur gear arrangement 130, via a toothed plug-type connection 122. The series gear 120 is fitted to the generator assembly 100 by means of elastic elements 123.

A feed line 180 runs from the winding arrangement of the armature 112 to a number of slip rings 191, which are fastened on a shaft plug-in part 190. The slip rings 191 interact with corresponding brushes 192, which are connected to a generator terminal 193. The generator terminal 193 is connected to the winding arrangement of the stator 111 via a further feed line 181.

A cover 200 is provided as a further housing part, said cover forming, together with the base mount component part 160, a housing for the generator 110.

The alternative embodiment 100′ illustrated in FIG. 3 in a schematic cross-sectional view differs from the embodiment 100 substantially only in terms of the configuration of the shaft 140′ and the armature mount 170′. The configuration shown in FIG. 3 makes it possible for the shaft 140′ to be removed from the cutout 163 toward the front and toward the rear (i.e. toward the left and toward the right in the figure), which enables simpler fitting and maintenance of the generator assembly 100′.

Instead of the double-fed asynchronous generator, it is also possible to use a permanent magnet synchronous generator.

1. A generator assembly for a wind energy installation, comprising:
a ring-shaped stator;
a ring-shaped armature;
a spur gear arrangement; and
a base mount component part, on which all of the bearings of the generator assembly are arranged.

2. The generator assembly as claimed in claim 1, wherein the armature is mounted rotatably on the base mount component part.

3. The generator assembly as claimed in claim 1, wherein at least one gear wheel of the spur gear arrangement is mounted rotatably on the base mount component part.

4. The generator assembly as claimed in claim 1, wherein a shaft bearing one of the gear wheels of the spur gear arrangement also bears the armature.

5. The generator assembly as claimed in claim 4, wherein at least one of the armature and the gear wheel are connected to the shaft by means of an in particular toothed plug-type connection.

6. The generator assembly as claimed in claim 1, wherein:
the base mount component part is in the form of a pot with a bottom face and a wall face, and
the stator is arranged on the wall face.

7. The generator assembly as claimed in claim 1, wherein a shaft bearing one of the gear wheels of the spur gear arrangement is mounted in a central cutout in the base mount component part.

8. The generator assembly as claimed in claim 1, wherein a second gear arrangement is connected upstream of the spur gear arrangement.

9. The generator assembly as claimed in claim 8, wherein the second gear arrangement and the spur gear arrangement are connected to one another by means of at least one elastic element.

10. The generator assembly as claimed in claim 1, wherein the generator is a double-fed asynchronous generator.

11. The generator assembly as claimed in claim 1, wherein the generator is a permanent magnet synchronous generator.

12. A wind energy installation, comprising: a generator assembly having
a ring-shaped stator,
a ring-shaped armature,
a spur gear arrangement, and
a base mount component part, on which all of the bearings of the generator assembly are arranged.
